(19) United States
(12) Patent Application Publication
(10) Pub. No.: US 2016/0155154 A1
(43) Pub. Date: Jun. 2, 2016

(54) SYSTEM AND METHOD FOR DYNAMIC PRICING IN A NETWORK ENVIRONMENT

(71) Applicant: MATCH.COM, L.L.C., Dallas, TX (US)

(72) Inventors: Monica D. Klawitter, Dallas, TX (US); Poossenjeet Bhattacharya, Dallas, TX (US); Jing Hao, Plano, TX (US)

(73) Assignee: MATCH.COM, L.L.C., Dallas, TX (US)

(21) Appl. No.: 14/556,712

(22) Filed: Dec. 1, 2014

(51) Int. Cl. G06Q 30/02; G06F 17/30

(52) U.S. Cl. CPC G06Q 30/0269; G06F 17/3053; G06F 17/30867

(57) ABSTRACT

A method is provided in one example embodiment and includes, for each user in a subset of users subscribed to a computer-implemented matching service, determining a score for the user, the score indicating a propensity of the user to resubscribe the computer-implemented matching service; determining whether to present a save offer to the user based on the scored determined for the user; and if a determination is made to present a save offer to the user, selecting from a plurality of save offers a save offer for which the user is eligible. The method may further include determining a decile to which the user belongs based on the score determined for the user relative to scores determined for remainder of the subset of users, in which the determining whether to present a save offer to the user is based on the decile to which the user is assigned.

### TECHNICAL FIELD

This disclosure relates in general to the field of communications and, more particularly, to a system and a method for dynamic pricing in a network environment.

### BACKGROUND

Communications network architectures have experienced significant popularity because they can offer the benefits of automation, convenience, and data management for their respective online communities. Certain network protocols may be used in order to allow an end user to be matched to other end users or to scenarios in which they stand to benefit (e.g., job searches, person-finding services, real estate searches, online dating, etc.).

In the case of an online dating service, for example, an end user will typically be prompted to specify a variety of preferences to be used in matching the end user with other end users in a particular online dating community. The information each end user provides about him or herself may be viewed by other end users in the online community in determining whether to interact with that end user. In certain cases, the actual dating platform can participate in matching activities. This interventionist involvement can often spur or provoke new relationships being formed.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a network diagram showing an operating environment of the present disclosure in accordance with one embodiment of the present disclosure;

FIGS. 2A-2J are simplified screen shots of an example protocol for participating in an on-line dating service in accordance with one embodiment of the present disclosure;

FIG. 3 illustrates a landing page for presenting a Save Offer to a user in accordance with embodiments of the present disclosure;

FIG. 4A illustrates a flowchart for implementing a propensity to resubscribe model in accordance with certain aspects of embodiments described herein;

FIG. 4B illustrates a flowchart for implementing a Save Offer model in accordance with certain aspects of embodiments described herein;

FIG. 5 illustrates an example cadence tables for use in connection with implementing a Save Offer model in accordance with embodiments of the present disclosure; and

FIG. 6 illustrates a simplified block diagram of a system for implementing a propensity to resubscribe and a Save Offer model in accordance with embodiments of the present disclosure.

### DETAILED DESCRIPTION OF EXAMPLE EMBODIMENTS

### Overview

A method is provided in one example embodiment and includes, for each user in a subset of users subscribed to a computer-implemented matching service, determining a score for the user, the score indicating a propensity of the user to resubscribe the computer-implemented matching service; determining whether to present a save offer to the user based on the scored determined for the user; and if a determination is made to present a save offer to the user, selecting from a plurality of save offers a save offer for which the user is eligible. The method may further include determining a decile to which the user belongs based on the score determined for the user relative to scores determined for remainder of the subset of users, in which the determining whether to present a save offer to the user is based on the decile to which the user is assigned.

In some embodiments, the method also includes determining a save offer cadence, wherein the save offer cadence indicates how often to present the selected save offer to the user. The cadence may be based on the decile to which the user is assigned and the selecting may be performed based on a subscription plan of the user. In certain embodiments, the selected save offer is presented to the user upon login of the user based on the determined cadence. Additionally, the determining a score for the user may include evaluating a number of factors for the user, including one or more of the user's personal habits, demographic information for the user, and an amount of computer-implemented matching service activity in which the user has participated.

### Example Embodiments

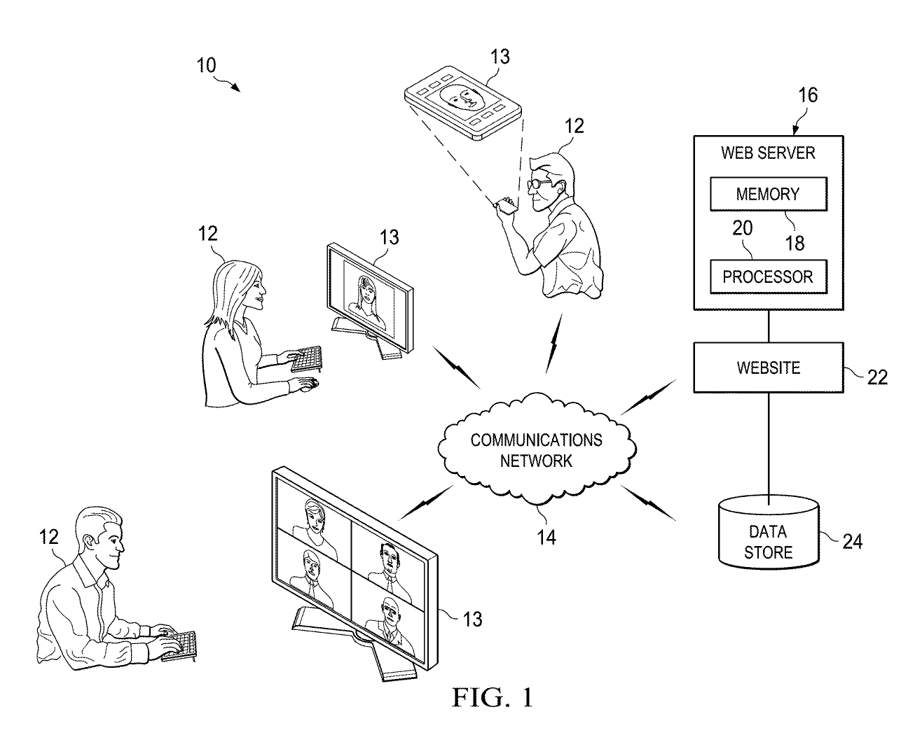

FIG. 1 is a simplified block diagram of a system 10 for facilitating an online dating scenario in a network environment. In other embodiments in which communications or matching is valuable, system 10 can be leveraged to identify and to evaluate suitable candidates in other areas (e.g., hiring/employment, recruiting, real estate, general person searches, etc.). FIG. 1 includes multiple end users 12 and endpoints 13, a communications network 14, one or more servers, represented in FIG. 1 by a web server 16, each comprising memory 18 and a at least one processor 20, a website 22, and a data store 24. Data store 24 may be any type of mechanism(s) for storing data, including but not limited to one or more files, databases, memory devices, mass storage devices, data centers, disk arrays, etc. System 10, users 12 interact with web server 16 via endpoints 13, each of which comprises an appropriate user interface for interacting with web server 16 via website 22 for facilitating functions and features described herein. In certain example implementations, website 22 and web server 16 are consolidated into a single component, physical structure, equipment, etc. In certain embodiments, an appropriate mobile application, or “mobile app,” may be installed on an endpoint for enabling a user to interact with the system 10, which interaction may or may not directly involve the website 22.

FIG. 1 may be configured such that inter- and intra-communications are readily achieved by any of the components included therein. The present disclosure is capable of providing both an online component (as illustrated in FIG. 1) and an off-line component such that one or more end users can meet, gather information, resolve to meet, and then subsequently meet in person with the assistance of system 10. Ancillary components to such a comprehensive process may involve pre-date profiles, post-date follow-ups, and a myriad of other significant features, some of which are outlined in detail below.

End users 12 may include a variety of types of end users, such as clients, customers, prospective customers, or entities wishing to participate in an online dating scenario and/or to view information associated with other participants in the system. End users 12 may also seek to access or to initiate communications with other end users that may be delivered via communications network 14. End users 12 may review data (such as user profiles, for example) associated with other users in order to make matching decisions or selections. Data, as used herein in this document, refers to any type of numeric, voice, video, or script data, or any other suitable information in any appropriate format that may be communicated from one point to another.

End users 12 may access the aforementioned data via endpoints 13, which may be inclusive of devices used to initiate a communication. Note that the broad term “user” encompasses any type of node or user device, or any type of endpoint discussed herein. Additionally, the term “user” can further include any type of profile to be used in the system discussed herein. Hence, the term “user” can include (but is not limited to) elements such as a computer, a personal digital assistant (PDA), a laptop or electronic notebook, a cellular telephone, an IP telephone, an iPhone™, an iPad™, a Microsoft Surface™, an Android™ phone, a Google Nexus™, or any other device, component, element, or object capable of initiating voice, audio, or data exchanges within communication system 10. The endpoints may be inclusive of a suitable interface to the end user 12, such as a microphone, a display, or a keyboard or other terminal equipment. Endpoints 13 may also include any device that seeks to initiate a communication on behalf of another entity or element, such as a program, a database, or any other component, device, element, or object capable of initiating a voice or a data exchange within communication system 10. In addition, each of the endpoints 13 may be a unique element designed specifically for communications involving system 10. Such an element may be fabricated or produced specifically for matching applications involving end user 12 and endpoint 13.

A user may employ any device capable of operating as an endpoint 13 to connect to communications network 14 via wire, wireless, cellular, satellite link or other suitable interfaces. Web server 16, which as previously noted includes memory 18 and at least one processor 20, hosts website 22 and has access to transmit and receive user or presence data (e.g., user profile data, user and/or user endpoint data, user contact data) from database 24. Presence data may be collected, aggregated, and utilized as required to facilitate communications between endpoints 12 over communications network 10 or other outside communication systems. Presence data may also include information and/or instructions enabling the creation, duration, and termination of communication sessions between diverse endpoints 13 that utilize different communication and/or networking protocols.

Communications network 14 is a communicative platform operable to exchange data or information emanating from endpoints 13. Communications network 14 represents an Internet architecture in a particular embodiment of the present disclosure, which provides end users 12 with the ability to electronically execute or to initiate actions associated with finding a potential match candidate. Alternatively, communications network 14 could be a plain old telephone system (POTS), which end user 12 could use to perform the same operations or functions. Such transactions may be assisted by management associated with website 22 or manually keyed into a telephone or other suitable electronic equipment. In other embodiments, communications network 14 could be any packet data network (PDN) offering a communications interface or exchange between any two nodes in system 10. Communications network 14 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

In one embodiment, web server 16 comprises a server that is operable to receive and to communicate information to one or more end users 12. In a generic sense, web server 16 can implement a computer-implemented matching system that provides a framework for suitable matching activities. Alternatively, web server 16 may be any switch, router, gateway, cache, server blade, software, processor, proprietary component, object, module, or element (or any combination of these) operable to facilitate communications involving end user 12. Web server 16 may be integrated with database 24 and/or website 22, where any one or more of these elements may share or otherwise coordinate the activities discussed herein.

In one particular embodiment, web server 16, via interaction with database 24 and/or in conjunction with website 22, is engaged in facilitating interaction(s) between parties interested in seeking a romantic partner (i.e., online dating). For example, website 22 can be online dating service provider www.Match.com, www.Chemistry.com, www.okcupid.com, or any other suitable provider. In certain example scenarios, a given end user may pay a fee for a subscription-based service (and potentially, only those users would qualify to be eligible to participate in events in certain example implementations, although other example embodiments involve non-members being eligible for participation). Additionally, certain end user fee structures may apply to different tiers of service: some of which may entitle an end user to enhanced features on website 22 (e.g., the ability to communicate more frequently with other users, additional matches being provided (potentially, more frequently) to an end user who paid the higher fee structure, the ability to store data, the ability to share data, the ability to upload additional information, the ability to target specific searches based on particular criteria, the ability to receive preferential positioning in the context of being matched to other users, the ability to perform video calls (e.g., Skype, etc.) with other users, the ability to perform audio calls with other users, etc.).

In certain embodiments, website 22 is a computer-implemented matching system, which may be any website or architecture provided for facilitating a connection involving two or more people, and which may make use of a given profile, photograph, resume, article description, etc. This could include services associated with job placements, auction services, social media, real estate listings, recruiting services (e.g., in athletics, academia, employment scenarios, instances involving the sales of goods and services), etc.

Considerable flexibility is provided by the structure of web server 16 and website 22 in the context of system 10. Thus, it can be easily appreciated that such functions could be provided external to web server 16 or website 22. In such cases, such a functionality could be readily embodied in a separate component, server, processor, device, or module. Note that these online dating features and capabilities may be provided in just one of these elements, in both, or distributed across both of them. Hence, in certain embodiments, the online dating operations may be consolidated in a single website, where no redirection is needed, nor performed for the user.

In operation of an example embodiment, consider a case where a given end user is interested in participating in an online dating scenario. End user 12 can access website 22 via the communications network 14 (which in the example presented comprises the Internet) using endpoint 13, register, and create a profile on the site. Moreover, end user 12 can access website 22 through any suitable banner, pop-up, partnership, e-mail solicitations, direct mailings, etc. It can be appreciated that online commerce can be generated by a plethora of marketing tools and any such tools can readily cooperate with the operations of the present disclosure.

At this point, matching of any form can commence amongst the members of the online community. For example, in the context of a romantic endeavor, a person may begin the dating process or engage in communications that would spawn such dating. Other applications could include job applicants who are being sought by employers. Any of the individuals who reside in the online community can begin using any of the tools or capabilities of the platform.

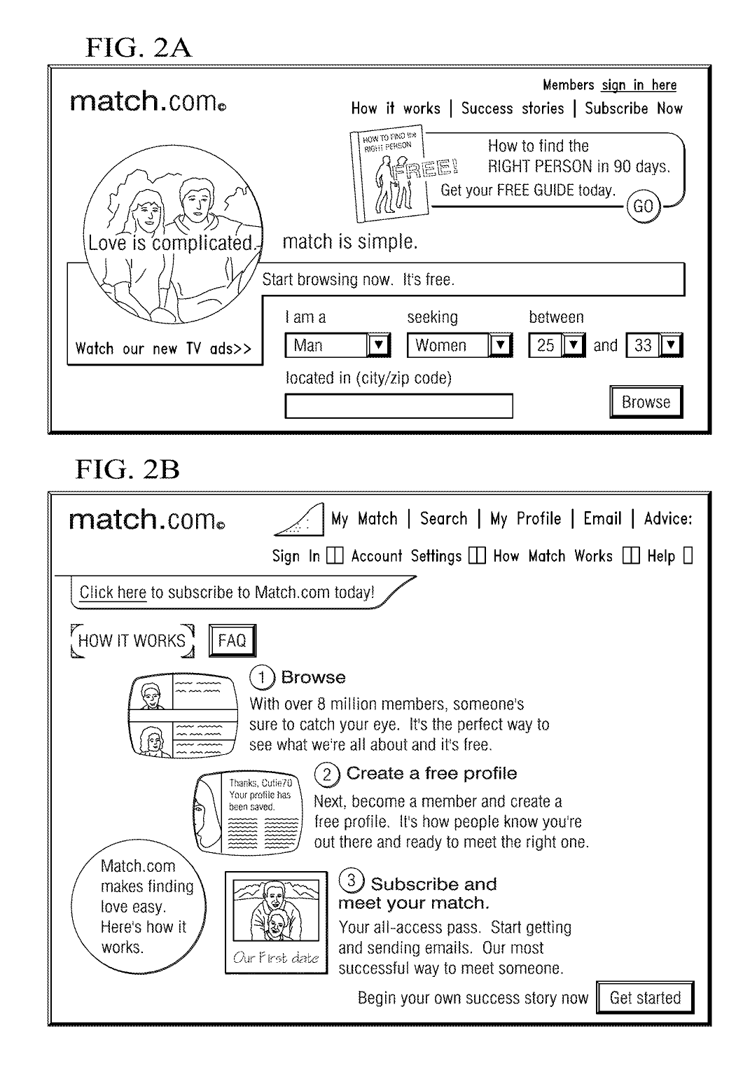

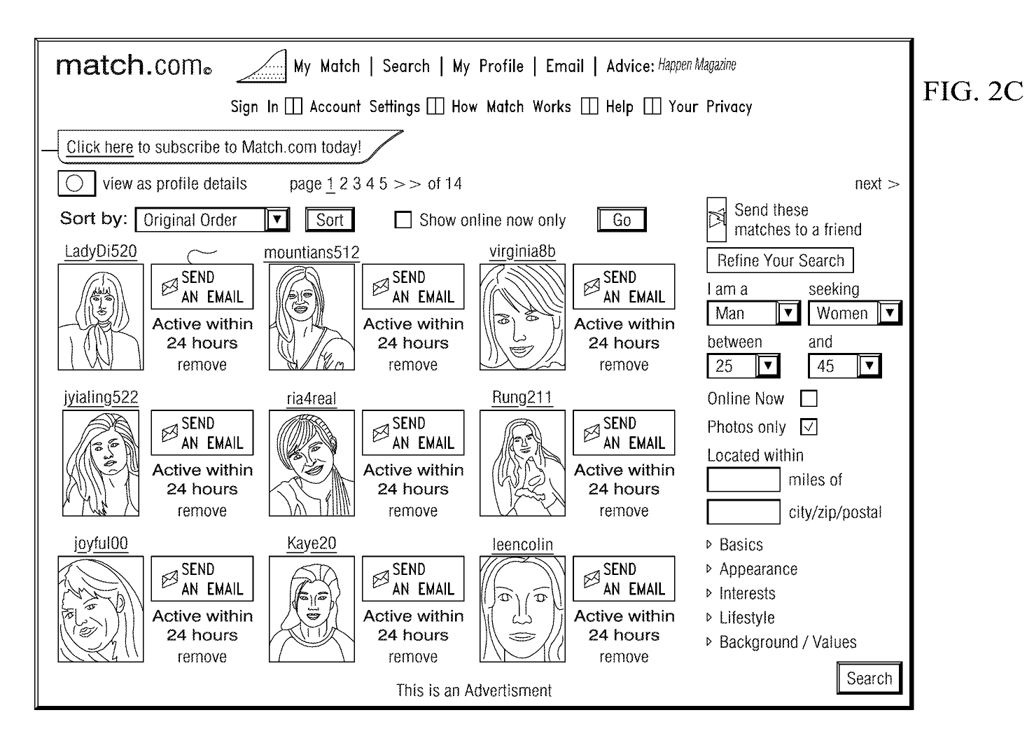

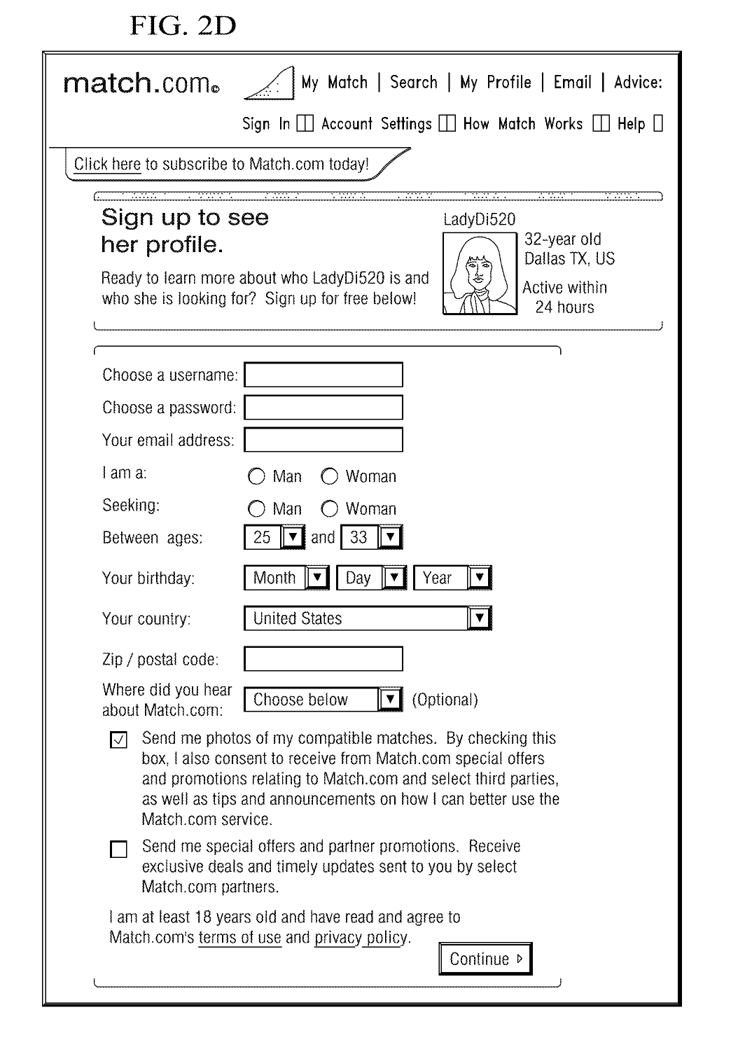

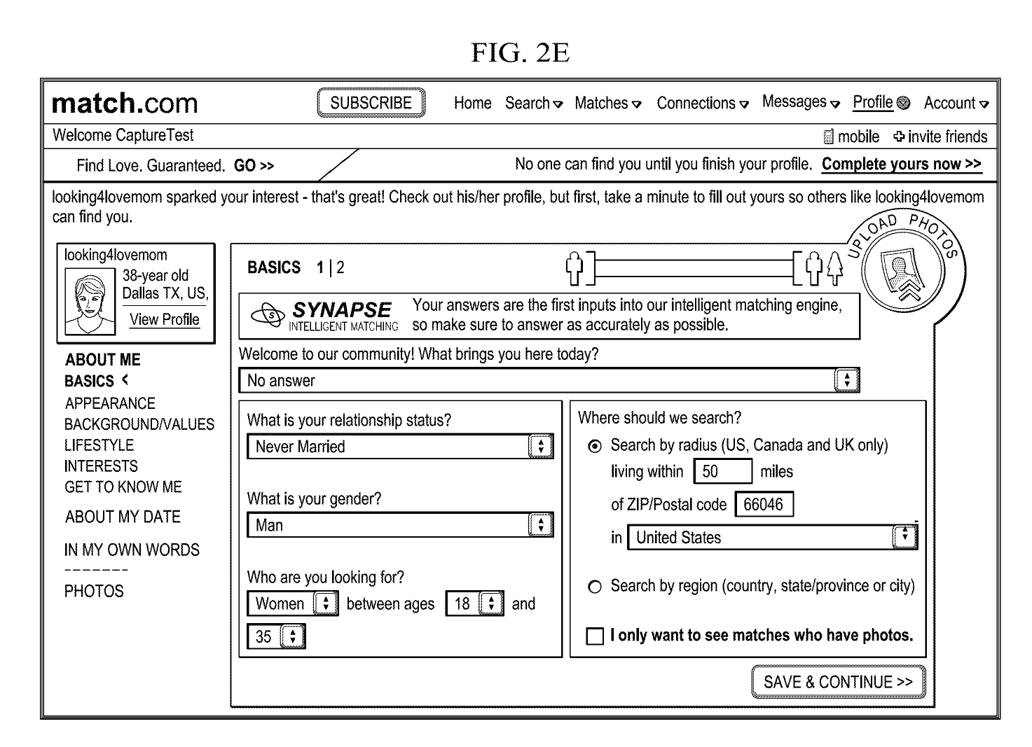

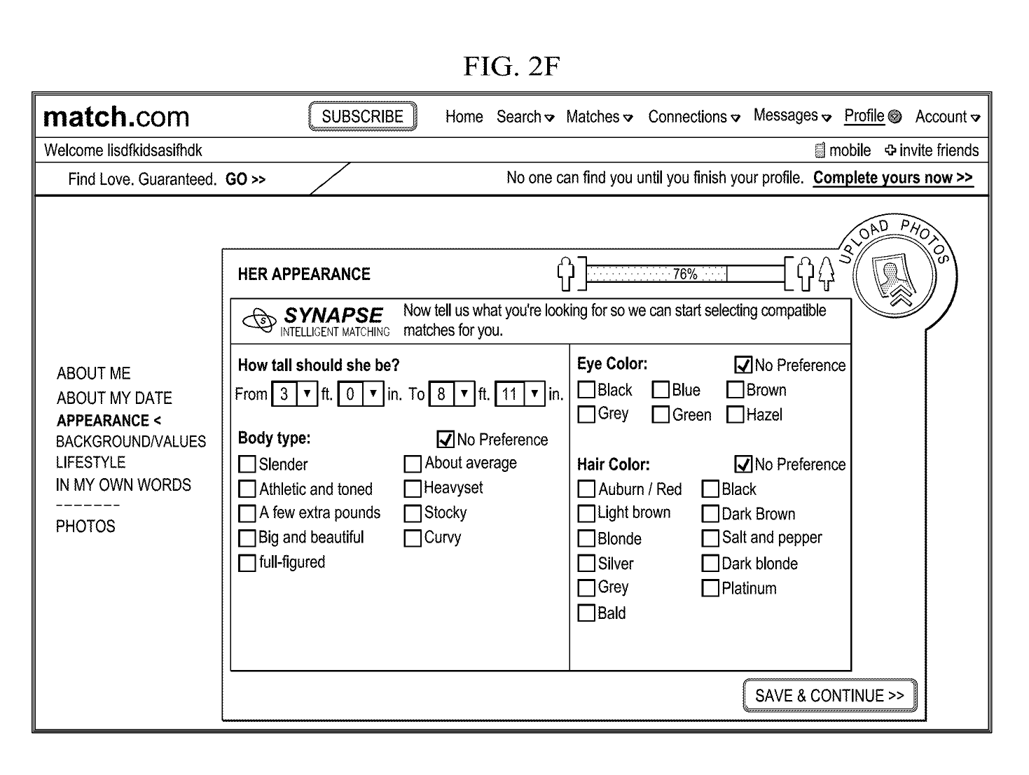

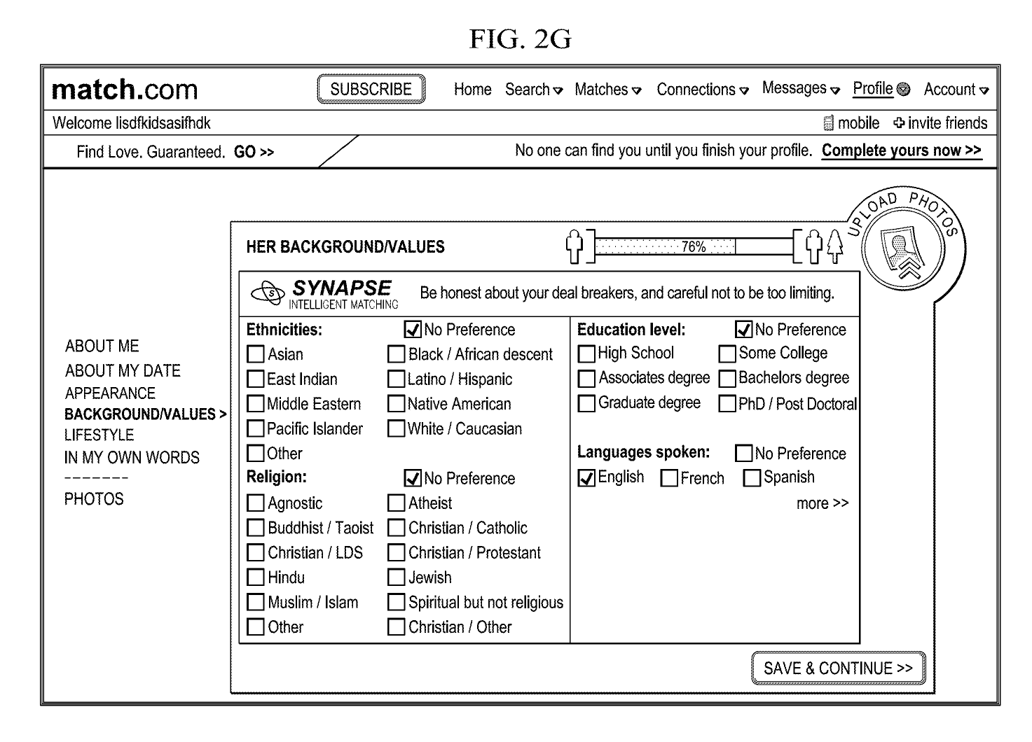

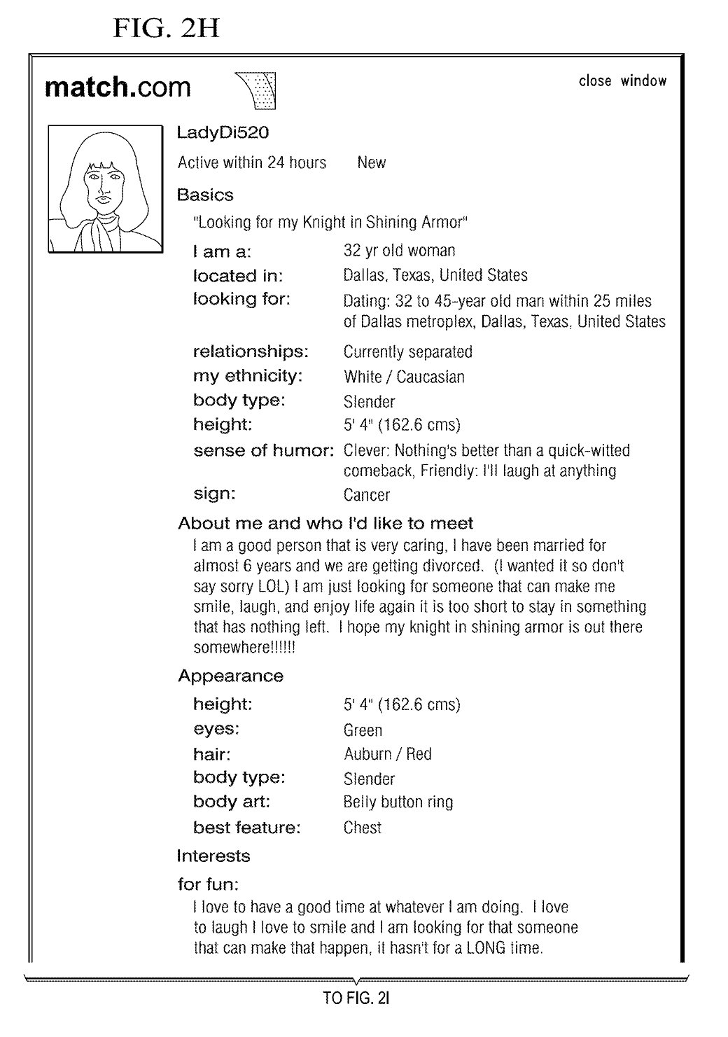

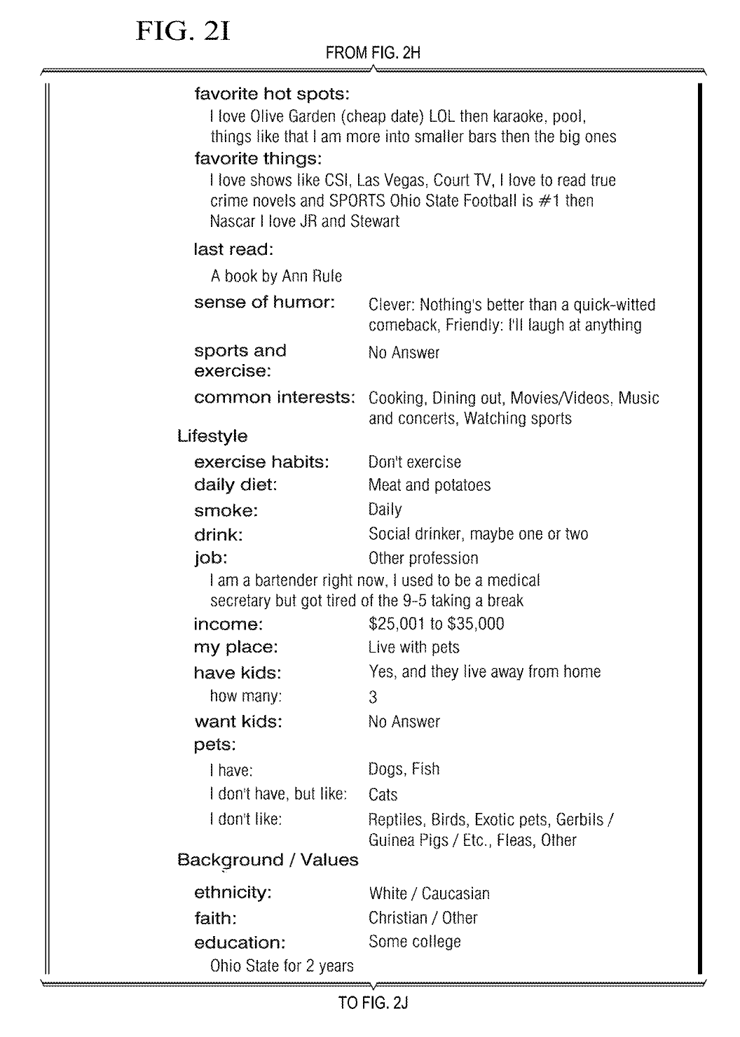

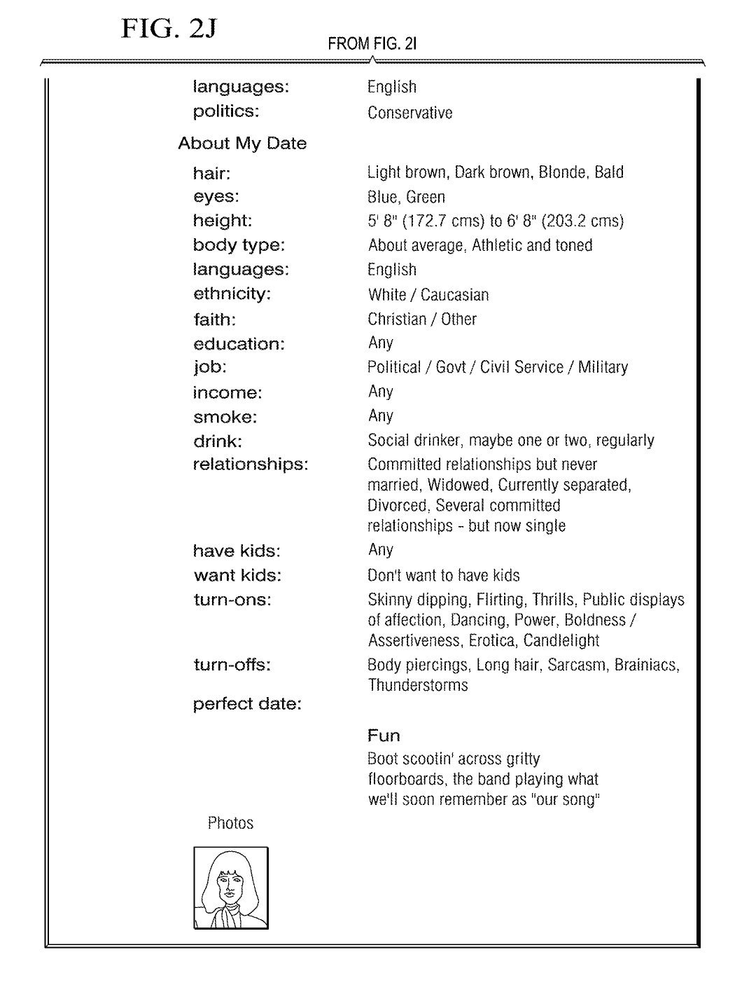

FIGS. 2A-2J illustrate example screen shots that may be provided in the online dating process to facilitate presentation of information to and gathering of information from member end users. FIGS. 2A-2J are presented herein for purposes of discussion. It is imperative to note that these illustrations are only being provided to further outline a particular implementation of the present disclosure. In no way should these diagrams be used to limit or to restrict the broad teachings of the present disclosure. Such illustrative information has been offered earnestly and, thus, should not be construed to confine the broad applications of the present disclosure.

FIG. 2A is an example screen shot of a home page from which an interested end user may begin his/her journey. In the illustrated example, the home page solicits location information, such as a city or zip code, as well as an indication of the end user's gender and an age range and gender preference of persons the end user is interested in “meeting” via system 10. Subsequent to the end user's completion of the requested information and clicking on a “How it Works” icon on the home page of FIG. 2A, a screen shot as shown in FIG. 2B is presented to the end user. The screen shot of FIG. 2B provides a generic outline of the online dating process. As outlined in the screen shot of FIG. 2B, as a first step, an end user may choose to browse the website to view pictures of members along with summaries of the members' profiles. After browsing the website, the end user may decide to create a free profile. Once the end user browses the website and creates a profile, the end user may opt to subscribe to the service and receive information from/about others who are part of the online community. For purposes of example and ease of explanation, it will be assumed for the remainder of the discussion of FIGS. 2A-2D that the potential new end user investigating and ultimately subscribing to the service is a male named “Tom” who is interested in finding a female match.

FIG. 2C is an example screen shot of a number of profiles that may be viewed by Tom during the browsing phase described above. In the context of this shot, Tom may be simply browsing. Assuming Tom has decided he would like to know more about one of the members whose profile is presented in FIG. 2C, he may click on the picture associated with the selected profile. For example, assuming Tom has decided he would like more information about “LadyDi520”, clicking on her picture results in his being directed to a web page as shown in FIG. 2D, where he is solicited to sign up for the online dating subscription such that he can effectively contact his candidate selection. It will be noted that the information solicited using the page shown in FIG. 2C may be used in selecting matches for Tom. The information may also be displayed on Tom's profile or summary thereof presented to other users to assist those users in determining whether they are interested in interacting with him.

FIGS. 2E-2G illustrate various screen shots comprising a user information collection process in accordance with one embodiment. Using the web pages illustrated in FIGS. 2E-2G, system 10 collects a variety of information from an end user, including, but not limited to, basic information about the end user (FIG. 2E), as well as information about the type person the end user would be interested in dating, including information about a potential date's physical appearance (FIG. 2F) and background and values (FIG. 2G). It will be recognized that the information collected using the web pages illustrated in FIGS. 2E-2G is illustrative only and that any type/amount of information may be solicited in the illustrated manner.

FIGS. 2H-2J are example screen shots of the full profile of LadyDi520, the picture Tom selected while browsing. In illustrated profile, LadyDi520's match criteria are displayed, as well as other information that may be pertinent to a potential mate. Any suitable items can be provided in such a profile (such as interests, favorite hot spots, favorite things, desire for children, background, etc.). Virtually any type or format of information (inclusive of video and audio data) may be provided in such a profile. In particular, the profile includes information that was solicited from LadyDi520 when she set up her online dating account. The profile may include a photo, biographical information (e.g., gender, age, location, relationship status, etc.), physical information (e.g., height, weight, hair and eye color, etc.), interests (e.g., hobbies, “favorites,” etc.), lifestyle information (e.g., exercise habits, employment, smoking/drinking habits, etc.), and background/values (e.g., ethnicity, faith, education, etc.). The profile may also include a section entitled “About My Date,” in which the end user specifies preferences about the type of person he/she would like to meet/date (e.g., appearance, interests, faith, education, relationship goals, etc.). In some embodiments, a full profile, including the profile information provided by the end user and stored in the system, is displayed to interested viewers; in other embodiments, only a summary or subset of the profile information is displayed.

In certain embodiments, it may be useful to a provider of an online dating service, such as that illustrated in FIG. 1, to evaluate certain characteristics of users to determine a price to charge for services in an attempt to impact users' propensity to purchase such services. In particular, this information could be used to predict how likely a particular user is to re-subscribe to services. In certain cases, discounts could be offered to potential re-subscribes based on the accumulated information, resulting in an intelligent discounting, or re-subscription propensity, model, which can be used to determine how often discounts should be offered to a particular user and an amount of discount to be offered to a particular user in order to incentivize a user to re-subscribe at the lowest cost to the service provider. In other words, the model may be used to predict the minimum discount that will incent a particular subscriber to re-subscribe to the services.

In certain embodiments, a discount offer, or “Save Offer,” is presented to users who have resigned from but not yet terminated the service. In some cases, these users are users that do not have an auto-renew feature enabled such that their subscription will not automatically renew at the end of their subscription period. In accordance with features of one embodiment, using the re-subscription propensity model, each resigned but not yet terminated user (i.e., a “qualified user”) may be scored based on numerous characteristics. The user's score indicates the user's propensity to re-subscribe. All of the qualified users are assigned to deciles (e.g., users with scores in the top 10% are may be assigned to a first decile, users in the next 10% are assigned to a second decile, and so on. Using these deciles, it is possible to optimize the how often, or the “cadence” at which, to present a Save Offer to qualified users in a manner that maximizes revenue and minimizes over-incentivization.

In some embodiments, qualified users comprising an “identified cohort” may be scored each day until service termination and the deciles for the cohort may be calculated every day. In one embodiment, the re-subscription propensity model assigns a “propensity to re-subscribe” score to each user of the cohort based on one or more of a number of user characteristics including but not limited to income, age, number of Daily 5 “yes” ratings within an immediately preceding time period (e.g., seven days), whether or not the user drinks, the user's level of education (e.g., high school, college, graduate school), the number of emails received by the user during an immediately preceding time period (e.g., seven days), a number of essays answered by the user, the user's gender, whether the user has a roommate, whether the user has answered certain questions provided in the profile section, whether the user has previously re-subscribed, the amount of time the user has spent on the website in an immediately preceding time period (e.g., seven days), whether the user's profile includes any photos, how many views the user's profile has gotten an immediately preceding time period (e.g., 24 hours), whether the user smokes, the number of winks received by the user during an immediately preceding time period (e.g., seven days), and the ratio of the number of users active during an immediately preceding time period (e.g., 60 days) to the number of registered users in the user's zip code. It should be noted that if at any point, a user accepts a Save Offer, as defined below, the user will be dropped from the cohort.

It will be noted that even though the user is scored every day, the data need not be perpetually persisted for the user. The data for a given package need only be persisted on certain weigh points for that package. For example, for a one month package, the weigh points may be the 14^{th} day before termination and the 7^{th} day before termination. For a three month package, the weigh points may be the 45^{th} day before termination, the 30^{th} day before termination, the 14^{th} day before termination, and the 7^{th} day before termination. For a six month package, the weigh points may be the 60^{th} day before termination, the 45^{th} day before termination, the 30^{th} day before termination, the 14^{th} day before termination, and the 7^{th} day before termination. In certain embodiments, the user's decile may be held static between weigh points, so as to prevent an abundance of fluctuation. For reporting purposes, the decile for a given user at each weigh point needs to be provided.

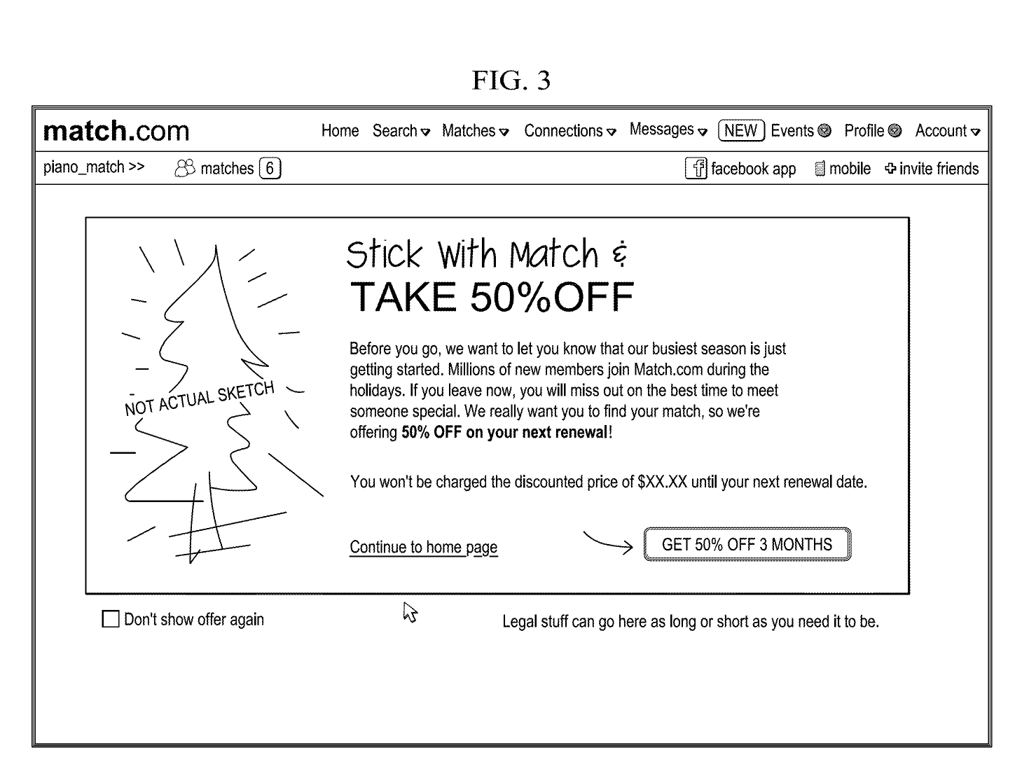

A “Save Offer” is defined as an offer to a user to re-subscribe at a discounted rate (e.g., 3-for-1, 30%, 50%, etc.). A Save Offer may be presented to a user via one or more of any number of methods, including upon site login, as a “sharkfin,” or via email, for example. Clicking on a Save Offer button or link conveyed to the user may result in the user's being taken to a Save Offer “landing page”, such as illustrated in FIG. 3, from which the user may redeem the offer by clicking the appropriate area on the landing page.

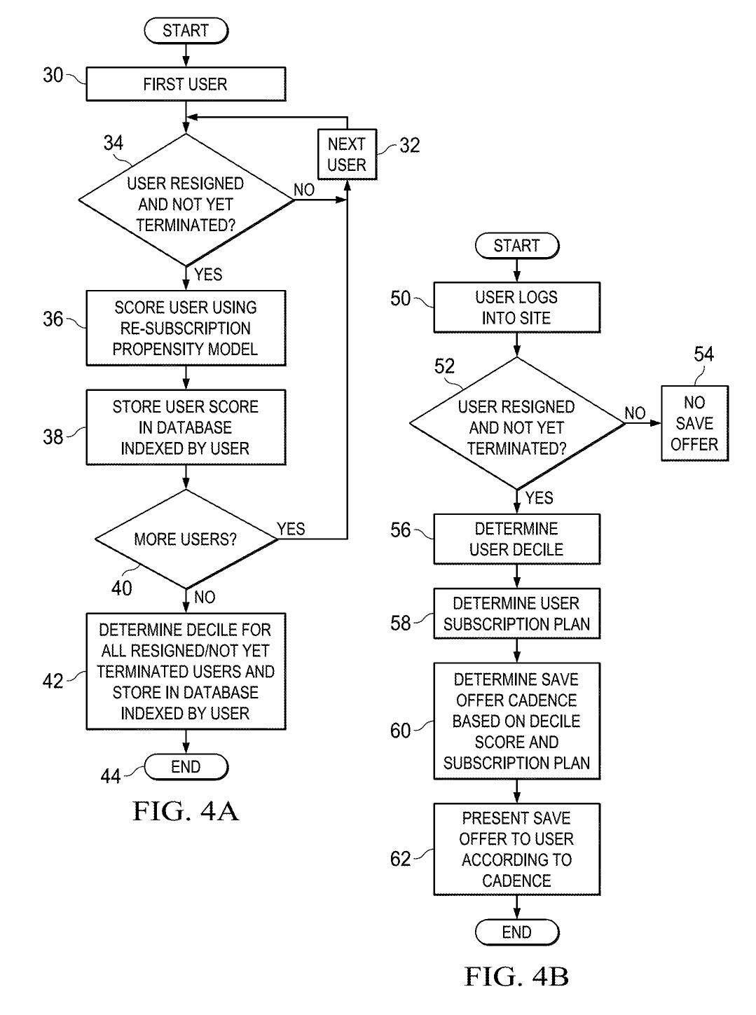

FIG. 4A illustrates a flowchart showing features of an embodiment for scoring users using a propensity to re-subscribe model. In step 30, a first user is identified. In step 32, a determination is made whether the identified user has resigned but not yet terminated his/her service (i.e., is a qualified user, or is part of the identified cohort). If not, execution proceeds to step 34, in which a next user is identified, and then returns to step 32. If in step 32 it is determined that the identified user is a qualified user (i.e., part of the cohort), execution proceeds to step 36. In step 36, the identified user is scored using the re-subscription propensity model.

As indicated above, scoring may be based on numerous factors, which may be weighted according to relative importance/impact on propensity to re-subscribe. In some embodiments, a logistic regression model is used in scoring to determine a level of engagement of a user, which may be correlated to a likelihood that the user will resubscribe. It may be assumed that the more engaged a user, the more likely a user is to resubscribe without incentive. Alternatively, the less engaged a user, the less likely the user is to resubscribe without an incentive. In certain embodiments, score is directly related to engagement, such that the higher the score, the greater the user's engagement and the lower the score, the lower the user's engagement. Once scoring is complete, in step 38, the user's score is stored in a database. In step 40, a determination is made whether there are more users. If so, execution returns to step 34; otherwise, execution proceeds to step 42. In step 42, each qualified user is assigned to a decile based on the user's score and the user's decile is stored in the database. In certain embodiments, users with scores in the top 10% of scores are assigned to decile 1, users with scores in the top 10-20% are assigned to decile 2, and so on, with users having scores in the bottom 10% of scores being assigned to decile 10. Execution terminates in step 44.

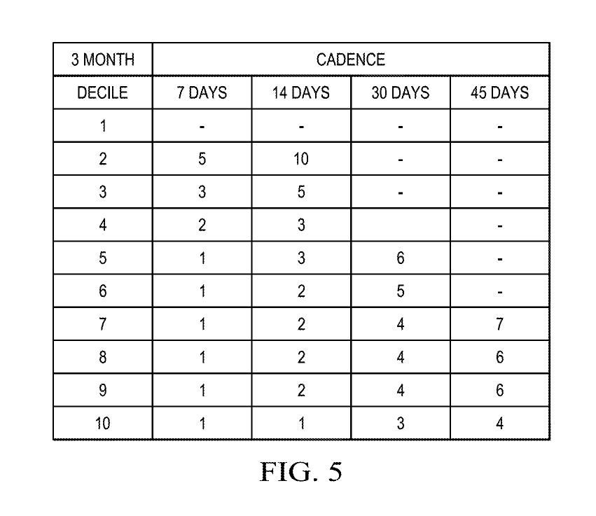

FIG. 4B illustrates a flowchart illustrating features of an embodiment for implementing a Save Offer model. In step 50, a user logs into the website. In step 52, a determination is made whether the user is resigned and not yet terminated (i.e., is part of the cohort). If not, execution proceeds to step 54 and proceeds normally with no Save Offer being presented. If it is determined in step 52 that the user is resigned and not yet terminated, execution proceeds to step 56, in which the user's decile score is retrieved from the database. In step 58, the user's subscription plan is identified; the user's subscription plan may determine the Save Offer for which the user is eligible. In step 60, the user's decile, subscription plan, and weigh point are used to determine a cadence at which (i.e., how frequently) the user will be presented with the appropriate Save Offer. Step 60 may be performed with reference to a subscription-specific cadence table, such as the example cadence table illustrated in FIG. 5. In particular, FIG. 5 illustrates a cadence table for users having three month subscriptions. The user is presented with the Save Offer in accordance with the cadence determined in step 60.

For example, assuming the user has a three month subscription (which may correspond to a 30% or 50% Save Offer) and the user's decile is 7, referring to the cadence table illustrated in FIG. 5, from the 45^{th} day before termination until the 30^{th} day before termination, the user will be presented with the Save Offer every 7^{th} login. From the 30^{th} day before termination to the 14^{th} day before termination, the user will be presented with the Save Offer every 4^{th} login. From the 14^{th} day before termination until the 7^{th} day before termination, the user will be presented with the Save Offer every 2^{nd} login and from the 7^{th} day before termination until the day of termination, the user will be presented with the Save Offer every login. In contrast, in some embodiments, a cadence table for a user in decile 7 having a one month subscription (which may correspond to a 3-for-1 Save Offer) may indicate that from the 14^{th} day before termination until the 7^{th} day before termination, the user will be presented with the Save Offer every 3^{rd} login and from the 7^{th} day before termination until the day of termination, the user will be presented with the Save Offer every 2^{nd} login. Similarly, in some embodiments, a cadence table for a user in decile 7 having a six month subscription (which may correspond to a 30% or 50% Save Offer) may indicate that from the 60^{th} day before termination until the 45^{th} day before termination, the user will be presented with the Save Offer every 5th login; from the 45^{th} day before termination until the 30^{th} day before termination, the user will be presented with the Save Offer every 4^{th} login; from the 30^{th} day before termination to the 14^{th} day before termination, the user will be presented with the Save Offer every 3^{rd} login; from the 14^{th} day before termination until the 7^{th} day before termination, the user will be presented with the Save Offer every 2^{nd} login; and from the 7^{th} day before termination until the day of termination, the user will be presented with the Save Offer every login.

Referring to FIG. 5, as indicated the cadence table illustrated therein, for users with three months subscriptions, users in decile 1 will not be displayed any save offers; users in deciles 2-4 will not be displayed any Save Offers until the 30^{th} day before termination, and users in deciles 5 and 6 will not be displayed any Save Offers until the 45^{th} day before termination. In contrast, in certain embodiments, for users with one month subscriptions, users in decile 1 may not be displayed any Save Offers and users in deciles 2 and 3 may not be displayed any Save Offers until the 7^{th} day before termination. Similarly, in certain embodiments, for users with six month subscriptions, users in decile 1 may not any Save Offers, users in decile 2 may not be displayed any Save Offers until the 14^{th} day before termination, and users in decile 3 may not be displayed any Save Offers until the 30^{th} day before termination, and users in deciles 4-5 may not be displayed any Save Offers until the 45^{th} day before termination.

In an alternative embodiment, the user's decile may also be used to determine a Save Offer amount to be presented to the user. For example, users in lower deciles (i.e., having higher scores) will presumably require less of an incentive to re-subscribe, whereas users in higher deciles (i.e., having lower scores) may require more of an incentive before being motivated to re-subscribe. In this alternative embodiment, incentive tables similar to the cadence table of FIG. 5 may be provided in which each entry in the table indicates an incentive to be offered to the user at the cadence identified in the corresponding cadence table entry.

It will be recognized that each user's score itself, rather than a decile, may be utilized directly determining an appropriate Save Offer cadence/incentive for the user. Additionally and/or alternatively, a more or less granular grouping of scores than deciles (e.g., quartiles) may be used to determine an appropriate Save Offer cadence/incentive for the user.

As previously noted, one of the user characteristics that may be used in calculating a propensity to re-subscribe score for a user is user income. However, it will be recognized that in many cases, even if a user opts to indicate an income in connection with his or her profile, that information may be inaccurate for a variety of reasons. For example, a user may indicate a higher than actual income in the hopes of not discouraging the interest of users for whom a low income may be deemed a negative quality. Alternatively, a user may indicate a lower than actual income in order to discourage the interest of users who the user perceives to be materialistic. In certain embodiments, therefore, an income prediction model may be used to predict income for users for use in a variety of applications, including propensity to re-subscribe. Similar to the propensity to re-subscribe model, the income prediction model uses a weighted combination of variables that have been determined to have a statistically significant relationship to actual income. Variables that may be included in the model include education level, occupation, ethnicity, residential zip code, number of languages spoken by the user, user interests and sports, user's living arrangement, and details about the user's original transaction (package purchased and total amount spent). Once calculated, the user's income score (and/or the income range to which it corresponds) may be stored in a database for later use. As previously noted, the income score/range information may be used in the system for a variety of purposes, such as Save Offer cadence/amount (indirectly via the propensity to re-subscribe model), matching algorithms, and other purposes.

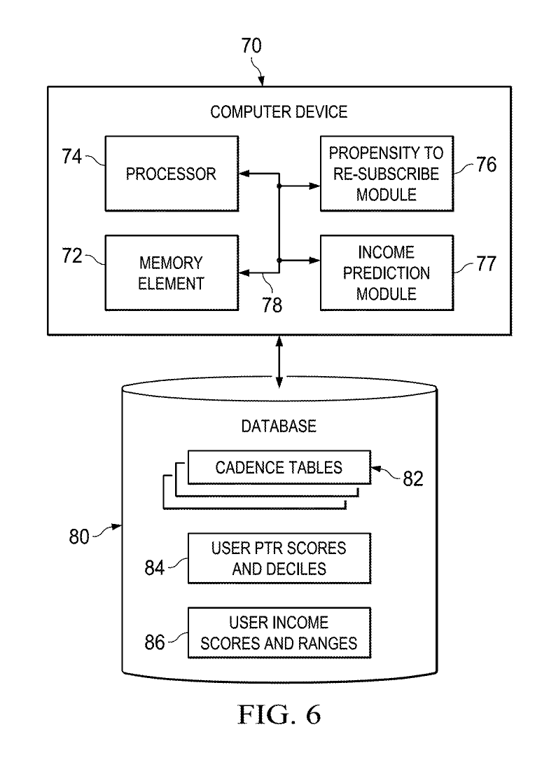

FIG. 6 illustrates a block diagram of elements of a system for implementing a propensity to re-subscribe model in accordance with features described herein. It will be noted that elements of the system of FIG. 6 may coincide and/or interact with elements of the system illustrated in FIG. 1 as necessary for performing the functions described herein. Referring to FIG. 6, the system includes a computer device 70 comprising memory 72, a processor 74, and a propensity to re-subscribe (“PTR”) module 76, and an optional income prediction module 77, all of which may be interconnected via a communications channel 78. The PTR module 76 may comprise software embodied in one or more tangible media for facilitating the activities described herein, including but not limited to those activities illustrated in and described with reference to FIGS. 4A and 4B. The income prediction module 77 may comprise software embodied in one or more tangible media for facilitating implementation of the income prediction model described above. Memory 72 may comprise a memory device or memory element for storing information to be used in achieving the functions as outlined herein. The processor 74 may comprise a processor that is capable of executing software or an algorithm (such as embodied in module 76) to perform the functions as discussed in this Specification.

Computer device 70 may be connected to a database 80 in which is stored cadence tables 82, user PTR scores and deciles 84, and optional user income scores and/or ranges 86. The user PTR scores and deciles 84 and optional user income scores and/or ranges 86 may comprise tables indexed by the user.

Note that in certain example implementations, the functions outlined herein and in FIGS. 4A and 4B may be implemented by logic encoded in one or more tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory element can store data used for the operations described herein. This includes the memory element being able to store software, logic, code, or processor instructions that are executed to carry out the activities described in this Specification, including but not limited to the functions illustrated in and described with reference to FIGS. 4A and 4B. A processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

It should be noted that much of the infrastructure discussed herein can be provisioned as part of any type of network element. As used herein, the term “network element” or “network device” can encompass computers, servers, network appliances, hosts, routers, switches, gateways, bridges, virtual equipment, load-balancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

In one implementation, network elements/devices can include software to achieve (or to foster) the management activities discussed herein. This could include the implementation of instances of any of the components, engines, logic, etc. shown in the FIGURES. Additionally, each of these devices can have an internal structure (e.g., a processor, a memory element, etc.) to facilitate some of the operations described herein. In other embodiments, these management activities may be executed externally to these devices, or included in some other network element to achieve the intended functionality. Alternatively, these network devices may include software (or reciprocating software) that can coordinate with other network elements in order to achieve the management activities described herein. In still other embodiments, one or several devices may include any suitable algorithms, hardware, software, components, modules, interfaces, or objects that facilitate the operations thereof.

Although the present disclosure has been described in detail with reference to particular embodiments, it should be understood that various other changes, substitutions, and alterations may be made hereto without departing from the spirit and scope of the present disclosure. For example, although the present disclosure has been described with reference to a dating protocol, any service that deals with (or that leverages) profiles, photos, resumes, user information more generally, etc. could readily benefit from the present disclosure.

Moreover, although the present disclosure has been described with reference to a number of elements included within system 10, these elements may be rearranged or positioned in any appropriate manner to accommodate any suitable networking configurations. In addition, any of the elements of FIG. 1 may be provided as separate external components to system 10 or to each other where appropriate.

It should also be noted that any of the question portions of the platform can leverage any type of format. Thus, in any aspect of the online dating process described herein, such as establishing a personality profile, for example, any suitable question format can be employed. Example formats include a Yes/No format, a multiple choice question format, a short answer format, a true/false format, etc. Other formats can readily be used in order to achieve the desired responses and solicit the appropriate data.

Note that in certain example implementations, the matching functions outlined herein, such as those carried out by web server 16 and/or provided as an application for an endpoint being operated by an end user (e.g., a mobile application for an iPhone™, an iPad™, an Android™ phone, or other mobile device), may be implemented by logic encoded in one or more non-transitory, tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory, as shown in FIG. 1, can store data used for the operations described herein. This includes the memory being able to store software, logic, code, or processor instructions that are executed to carry out the activities described in this Specification.

A processor can execute any type of instructions associated with the data to achieve the operations detailed herein in this Specification. In one example, the processor, as shown in FIG. 1, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

These devices illustrated herein may maintain information in any suitable memory (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that with the example provided above, as well as numerous other examples provided herein, interaction may be described in terms of more than one network element. However, this has been done for purposes of clarity and example only. In certain cases, it may be easier to describe one or more of the functionalities of a given set of flows by only referencing a limited number of network elements. It should be appreciated that system 10 (and its teachings) are readily scalable and can accommodate a large number of components, as well as more complicated/sophisticated arrangements and configurations. Accordingly, the examples provided should not limit the scope or inhibit the broad teachings of system 10 as potentially applied to myriad other architectures.

It is also important to note that the steps in the preceding flow diagrams illustrate only some of the possible signaling scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure. Although the present disclosure has been described in detail with reference to particular arrangements and configurations, these example configurations and arrangements may be changed significantly without departing from the scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
for each user in a subset of users subscribed to a computer-implemented matching service:
determining a score for the user, the score indicating a propensity of the user to resubscribe the computer-implemented matching service;
determining whether to present a save offer to the user based on the scored determined for the user; and
if a determination is made to present a save offer to the user, selecting from a plurality of save offers a save offer for which the user is eligible.

2. The method of claim 1, further comprising:
determining a decile to which the user belongs based on the score determined for the user relative to scores determined for remainder of the subset of users;
wherein the determining whether to present a save offer to the user is based on the decile to which the user is assigned.

3. The method of claim 2 further comprising determining a save offer cadence, wherein the save offer cadence indicates how often to present the selected save offer to the user.

4. The method of claim 3, wherein the cadence is based on the decile to which the user is assigned.

5. The method of claim 1 wherein the selecting is performed based on a subscription plan of the user.

6. The method of claim 3 wherein the selected save offer is presented to the user upon login of the user based on the determined cadence.

7. The method of claim 1, wherein the determining a score for the user comprises evaluating a number of factors for the user, including one or more of the user's personal habits, demographic information for the user, and an amount of computer-implemented matching service activity in which the user has participated.

8. One or more non-transitory tangible media that includes code for execution and when executed by a processor is operable to perform operations comprising:
for each user in a subset of users subscribed to a computer-implemented matching service:
determining a score for the user, the score indicating a propensity of the user to resubscribe the computer-implemented matching service;
determining whether to present a save offer to the user based on the scored determined for the user; and
if a determination is made to present a save offer to the user, selecting from a plurality of save offers a save offer for which the user is eligible.

9. The media of claim 8, wherein the operations further comprise:
determining a decile to which the user belongs based on the score determined for the user relative to scores determined for remainder of the subset of users;
wherein the determining whether to present a save offer to the user is based on the decile to which the user is assigned.

10. The media of claim 9, wherein the operations further comprise determining a save offer cadence, wherein the save offer cadence indicates how often to present the selected save offer to the user.

11. The media of claim 10, wherein the cadence is based on the decile to which the user is assigned.

12. The media of claim 8 wherein the selecting is performed based on a subscription plan of the user.

13. The media of claim 10 wherein the selected save offer is presented to the user upon login of the user based on the determined cadence.

14. The media of claim 8, wherein the determining a score for the user comprises evaluating a number of factors for the user, including one or more of the user's personal habits, demographic information for the user, and an amount of computer-implemented matching service activity in which the user has participated.

15. An apparatus, comprising a processor and a memory, wherein the apparatus is configured to:
for each user in a subset of users subscribed to a computer-implemented matching service:
determine a score for the user, the score indicating a propensity of the user to resubscribe the computer-implemented matching service;
determine whether to present a save offer to the user based on the scored determined for the user; and
if a determination is made to present a save offer to the user, select from a plurality of save offers a save offer for which the user is eligible.

16. The apparatus of claim 15, wherein the apparatus is further configured to:
determine a decile to which the user belongs based on the score determined for the user relative to scores determined for remainder of the subset of users;
wherein the determining whether to present a save offer to the user is based on the decile to which the user is assigned.

17. The apparatus of claim 16, wherein the apparatus is further configured to determine a save offer cadence, wherein the save offer cadence indicates how often to present the selected save offer to the user.

18. The apparatus of claim 17, wherein the cadence is based on the decile to which the user is assigned.

19. The apparatus of claim 15, wherein the selecting is performed based on a subscription plan of the user and wherein the selected save offer is presented to the user upon login of the user based on the determined cadence.

20. The apparatus of claim 15, wherein the determining a score for the user comprises evaluating a number of factors for the user, including one or more of the user's personal habits, demographic information for the user, and an amount of computer-implemented matching service activity in which the user has participated.
